(19) United States
(12) Patent Application Publication
(10) Pub. No.: US 2016/0313877 A1
(43) Pub. Date: Oct. 27, 2016

(54) ELECTRONIC DEVICE AND METHOD FOR DISPLAYING MESSAGE IN ELECTRONIC DEVICE

(71) Applicant: Samsung Electronics Co., Ltd., Gyeonggi-do (KR)

(72) Inventors: Da-Yun HA, Seoul (KR); Min-Kyung Hwang, Seoul (KR); Jeong-Hyun Pang, Gyeonggi-do (KR); Yong-Joon Jeon, Gyeonggi-do (KR)

(73) Assignee: Samsung Electronics Co., Ltd.

(21) Appl. No.: 15/137,320

(22) Filed: Apr. 25, 2016

(30) Foreign Application Priority Data
Apr. 23, 2015 (KR) 10-2015-0057317

(51) Int. Cl. G06F 3/0482; G06F 3/0484; G06F 3/0485; H04L 12/58; G06F 3/0488

(52) U.S. Cl. CPC G06F 3/0482; H04L 51/04; H04L 51/24; G06F 3/04883; G06F 3/0485; G06F 3/04845; G06F 3/04842; G06F 3/04886

(57) ABSTRACT

Methods and apparatuses are provided for displaying a message by an electronic device. A reception notification for a new message is displayed on an existing chat window on a display screen of the electronic device. At least a portion of the new message is displayed for a predetermined time on the display screen, when a gesture event occurs in a predetermined area of the display screen corresponding to the reception notification.

### PRIORITY

This application claims priority under 35 U.S.C. §119(a) to Korean Patent Application No. 10-2015-0057317, filed in the Korean Intellectual Property Office on Apr. 23, 2015, the entire disclosure of which is incorporated herein by reference.

### BACKGROUND

1. Field of the Disclosure

The present disclosure relates generally to electronic devices, and more particularly, to methods for displaying messages in electronic devices.

2. Description of the Related Art

An electronic device may provide functions such as an alarm, a short messaging service (SMS), a multimedia message service (MMS), email, a game, short-range communication remote control, image capturing functions using an equipped digital camera, multimedia functions for providing audio and video contents, scheduling functions, and other similar functions.

Further, recent electronic devices provide interactive message transmission/reception functions through various applications for messaging with another party.

Typically, an interactive messaging function allows messages to be transmitted/received through a chat window or conversation view. According to the interactive messaging function of electronic device, when a new message is received from a third party, that is not the other party in the chat window, while communicating messages in the chat window, a shift is required from the chat window screen to the message reception screen to check the new message.

For example, a user desiring to check new messages while messaging on the chat window shifts the chat window screen to the received message list screen, selects a new message from the received message list screen, and switches to the new message screen. After checking the message on the message screen, the user switches the message screen to the chat window screen. As such, the user performs several steps to check a new message while messaging in the chat window, and the electronic device needs to carry out multiple steps of page shift for screen switching. This results in inefficiency and interrupts the chat on the chat window.

When several messages are received from different senders while messaging in the chat window, more screen switches and page shifts are required than when only one message is checked. Thus, there is a need for an efficient method for checking new messages while chatting in the chat window.

### SUMMARY

The present disclosure has been made to address at least the above problems and/or disadvantages and to provide at least the advantages described below. Accordingly, an aspect of the present disclosure provides an electronic device and a method for displaying messages in the electronic device, which, upon arrival of a new message while messaging in a chat window, allows the new message to be checked in an efficient manner.

According to another aspect of the present disclosure, an electronic device and a method are provided for displaying messages in the electronic device, which, upon reception of a new message while messaging on the chat window, allow for check of the new message without screen switching or page shift and then going quickly back to the chat.

According to an embodiment of the present disclosure, an electronic device is provided that includes a communication module, a display, a memory, and a processor. The processor is configured to display a reception notification for a new message on an existing chat window on a screen of the display. The processor is also configured to display at least a portion of the new message for a predetermined time on the screen when a gesture event occurs in a predetermined area of the screen corresponding to the reception notification.

According to an embodiment of the present disclosure, a method is provided for displaying a message by an electronic device. A reception notification for a new message is displayed on an existing chat window on a display screen of the electronic device. At least a portion of the new message is displayed for a predetermined time on the display screen, when a gesture event occurs in a predetermined area of the display screen corresponding to the reception notification.

According to an embodiment of the present disclosure, an article of manufacture is provided for displaying a message by an electronic device. The article of manufacture includes a non-transitory machine readable medium containing one or more programs which when executed implement the steps of: displaying a reception notification for a new message on an existing chat window on a display screen of the electronic device; and displaying at least a portion of the new message for a predetermined time on the display screen, when a gesture event occurs in a predetermined area of the display screen corresponding to the reception notification.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a diagram illustrating a network environment including an electronic device, according to an embodiment of the present disclosure;

FIG. 2 is a block diagram illustrating an electronic device, according to an embodiment of the present disclosure;

FIG. 3 is a block diagram illustrating a program module, according to an embodiment of the present disclosure;

FIG. 4 is a flowchart illustrating an operation of displaying a new message while in a chat in an electronic device, according to an embodiment of the present disclosure;

FIGS. 5A-5D are diagrams illustrating contention window layers, according to an embodiment of the present disclosure;

FIGS. 6A-6E are diagrams illustrating a process of displaying a multi-chat window including a chat window and a new message chat window upon reception of a new message on the chat window, according to an embodiment of the present disclosure;

FIGS. 7A-7E are diagrams illustrating a process in which a chat window switches to a new message chat window upon reception of a new message on the chat window, according to an embodiment of the present disclosure;

FIGS. 8A-8C are diagrams illustrating a scheme of displaying a new message chat window on a chat window, according to an embodiment of the present disclosure;

FIGS. 9A-9D are diagrams illustrating a scheme of notifying a new message, according to an embodiment of the present disclosure;

FIGS. 10A-10B, 11A-11C, 12A-12C, and 13A-13C are diagrams illustrating a scheme of notifying new messages when a plurality of new messages are received according to an embodiment of the present disclosure;

FIG. 14 is a flowchart illustrating an input operation on each chat window while a multi-chat window is displayed, according to an embodiment of the present disclosure;

FIGS. 15A-15C and 16A-16C are diagrams illustrating screens upon an input operation on each chat window while a multi-chat window is displayed, according to an embodiment of the present disclosure;

FIG. 17 is a flowchart illustrating an operation of switching a multi-chat window into a group chat window while the multi-chat window is displayed, according to an embodiment of the present disclosure; and

FIGS. 18A-18D are diagrams illustrating a screen upon an operation of switching a multi-chat window into a group chat window according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

As used herein, the terms “have,” “may have,” “include,” and “may include” indicate the existence of a feature (e.g., a number, function, operation, or a component such as a part), and do not exclude the existence of other features.

As used herein, the terms “A or B,” “at least one of A and B,” and “one or more of A and B” may include all possible combinations of A and B. For example, “A or B,” “at least one of A and B,” “at least one of A and B” may indicate all of (1) including at least one A, (2) including at least one B, or (3) including at least one A and at least one B.

As used herein, the terms “first” and “second” may modify various components regardless of importance and/or order and are used to distinguish a component from another component without limiting the components. For example, a first user device and a second user device may indicate different user devices regardless of the order or importance of the devices. Additionally, a first component may be referred to as a second component, and vice versa, without departing from the scope of the present disclosure.

It will be understood that when an element (e.g., a first element) is referred to as being (operatively or communicatively) “coupled with/to,” or “connected with/to” another element (e.g., a second element), it can be directly coupled or connected with/to the other element or coupled via a third element. In contrast, it will be understood that when an element (e.g., the first element) is referred to as being “directly coupled with/to” or “directly connected with/to” another element (e.g., the second element), no other element (e.g., the third element) is disposed between the element and the other element.

As used herein, the phrase “configured (or set) t” may be interchangeably used with the phrases “suitable for,” “having the capacity to,” “designed to,” “adapted to,” “made to,” or “capable of” depending on circumstances. The phrase “configured (or set) to” does not mean “specifically designed in hardware to.” Rather, the phrase “configured to” may mean that a device can perform an operation together with another device or parts. For example, the phrase “processor configured (or set) to perform A, B, and C” may mean a generic-purpose processor (e.g., a central processing unit (CPU) or an application processor (AP)) that may perform the operations by executing one or more software programs stored in a memory device or a dedicated processor (e.g., an embedded processor) for performing the operations.

The terms as used herein are provided merely to describe some embodiments of the present disclosure, and not to limit the scope of other embodiments of the present disclosure. It is to be understood that the singular forms “a,” “an,” and “the” include plural references unless the context clearly dictates otherwise. Technical and scientific terms used herein have the same meanings as those commonly understood by one of ordinary skill in the art to which the embodiments of the present disclosure belong. It will be further understood that terms, such as those defined in commonly used dictionaries, should be interpreted as having meanings that are consistent with their meanings in the context of the relevant art and will not be interpreted in an idealized or overly formal sense unless expressly so defined herein. In some cases, the terms defined herein may be interpreted to exclude embodiments of the present disclosure.

For example, examples of the electronic device according to embodiments of the present disclosure, may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device. According to an embodiment of the present disclosure, the wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device (e.g., an implantable circuit).

According to an embodiment of the present disclosure, the electronic device may be a home appliance. For example, examples of the smart home appliance may include at least one of a television, a digital versatile disc (DVD) player, an audio player, a refrigerator, an air conditioner, a cleaner, an oven, a microwave oven, a washer, a drier, an air cleaner, a set-top box, a home automation control panel, a security control panel, a television (TV) box, a gaming console, an electronic dictionary, an electronic key, a camcorder, or an electronic picture frame.

According to an embodiment of the present disclosure, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, automatic teller machines (ATMs), point of sales (POS) devices, or Internet of Things (IoT) devices (e.g., a light bulb, various sensors, an electric or gas meter, a sprinkler, a fire alarm, a thermostat, a street light, a toaster, fitness equipment, a hot water tank, a heater, or a boiler).

According to various embodiments of the disclosure, examples of the electronic device may be at least one of furniture, part of a building/structure, an electronic board, an electronic signature receiving device, a projector, or various measurement devices (e.g., devices for measuring water, electricity, gas, or electromagnetic waves). According to an embodiment of the present disclosure, the electronic device may be one or a combination of the above-listed devices. According to an embodiment of the present disclosure, the electronic device may be a flexible electronic device. The electronic device disclosed herein is not limited to the above-listed devices, and may include new electronic devices depending on the development of new technologies.

Hereinafter, electronic devices are described with reference to the accompanying drawings, according to embodiments of the present disclosure. As used herein, the term “user” may denote a human or another device (e.g., an artificial intelligent electronic device) using the electronic device.

According to embodiments of the present disclosure, checking a new message and going back to the chat may be achieved without several steps of screen switching or page shifts for checking new messages while messaging on the chat window.

According to embodiments of the present disclosure, even when several messages are received from different senders while messaging on the chat window, the new messages may be quickly checked on the chat window.

According to embodiments of the present disclosure, it may be possible to quickly check one or more new messages on the chat window and go back to the chat, leading to efficient multitasking in the messaging application.

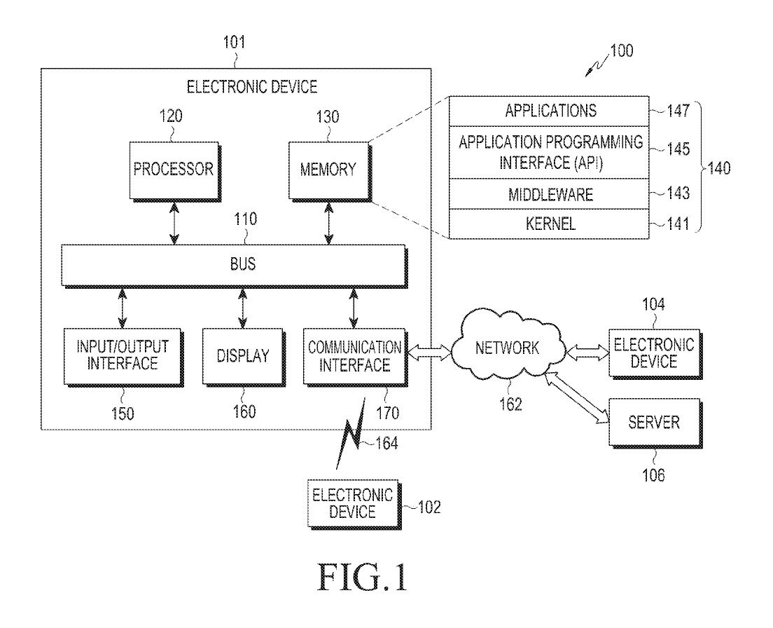

Referring initially to FIG. 1, a diagram illustrates an electronic device in a network environment, according to an embodiment of the present disclosure. An electronic device 101 in a network environment 100 includes a bus 110, a processor 120, a memory 130, an input/output interface 150, a display 160, and a communication interface 170. In some embodiments, the electronic device 101 may exclude at least one of the components or may add at least one other component.

The bus 110 may include a circuit for connecting the components 110 to 170 with one another and transferring communications (e.g., control messages and/or data) between the components.

The processing module 120 may include one or more of a CPU, an AP, and a communication processor (CP). The processor 120 may control at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 stores software and/or a program 140. The program 140 includes a kernel 141, middleware 143, an application programming interface (API) 14.5, and/or an application program (or “application”) 147. At least a portion of the kernel 141, middleware 143, or API 145 may be referred to as an operating system (OS).

For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example.

Further, the middleware 143 may process one or more task requests received from the application program 147 in order of priority. For example, the middleware 143 may assign at least one of application programs 147 with priority of using system resources (e.g., the bus 110, processor 120, or memory 130) of at least one electronic device 101. For example, the middleware 143 may perform scheduling or load balancing on the one or more task requests by processing the one or more task requests according to the priority assigned to the at least one application program 147.

The API 145 is an interface allowing the application 147 to control functions provided from the kernel 141 or the middleware 143. For example, the API 145 may include at least one interface or function (e.g., a command) for filing control, window control, image processing or text control.

The input/output interface 150 may serve as an interface that may, e.g., transfer commands or data input from a user or another external device to other component(s) of the electronic device 101. Further, the input/output interface 150 may output commands or data received from other component(s) of the electronic device 101 to the user or the other external device.

The display 160 may include, e.g., a liquid crystal display (LCD), a light emitting diode (LED) display, an organic light emitting diode (OLED) display, a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity, or hovering input using an electronic pen or a body part of the user.

For example, the transmission/reception unit 170 may configure communication between the electronic device 101 and an external device. Additionally, the communication interface 170 may be wiredly or wirelessly connected with a network 162 to communicate with an external electronic device.

The wireless communication may be a cellular communication protocol and may use at least one of, e.g., long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). Further, the wireless communication may include, e.g., short-range communication 164. The short-range communication 164 may include at least one of wireless fidelity (Wi-Fi), Bluetooth, near-field communication (NFC), or global navigation satellite system (GNSS). The GNSS may include at least one of, e.g., global positioning system (GPS), global navigation satellite system (Glonass), Beidou navigation satellite system (Beidou) or Galileo, the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, or plain old telephone service (POTS). The network 162 may include at least one of telecommunication networks, e.g., a computer network (e.g., local area network (LAN) or wide area network (WAN)), Internet, or a telephone network.

First and second external electronic devices 102 and 104 each may be a device of the same type as or a different type from the electronic device 101. According to an embodiment of the present disclosure, a server 106 may include a group of one or more servers. According to an embodiment of the present disclosure, all or some of operations executed on the electronic device 101 may be executed on one or more other electronic devices (e.g., the first external electronic device 102, the second external electronic device 104, and/or the server 106). According to an embodiment of the present disclosure, when the electronic device 101 should perform some function or service automatically or at a request, instead of executing the function or service on its own, the electronic device 101 may request another device (e.g., the first external electronic device 102, the second external electronic device 104, or the server 106) to perform at least some functions associated therewith. The other electronic device (e.g., the first external electronic device 102, the second external electronic device 104, or the server 106) may execute the requested functions or additional functions and transfer a result of the execution to the electronic device 101. The electronic device 101 may provide a requested function or service by processing the received result. Cloud computing, distributed computing, or client-server computing technique may be used in processing, for example.

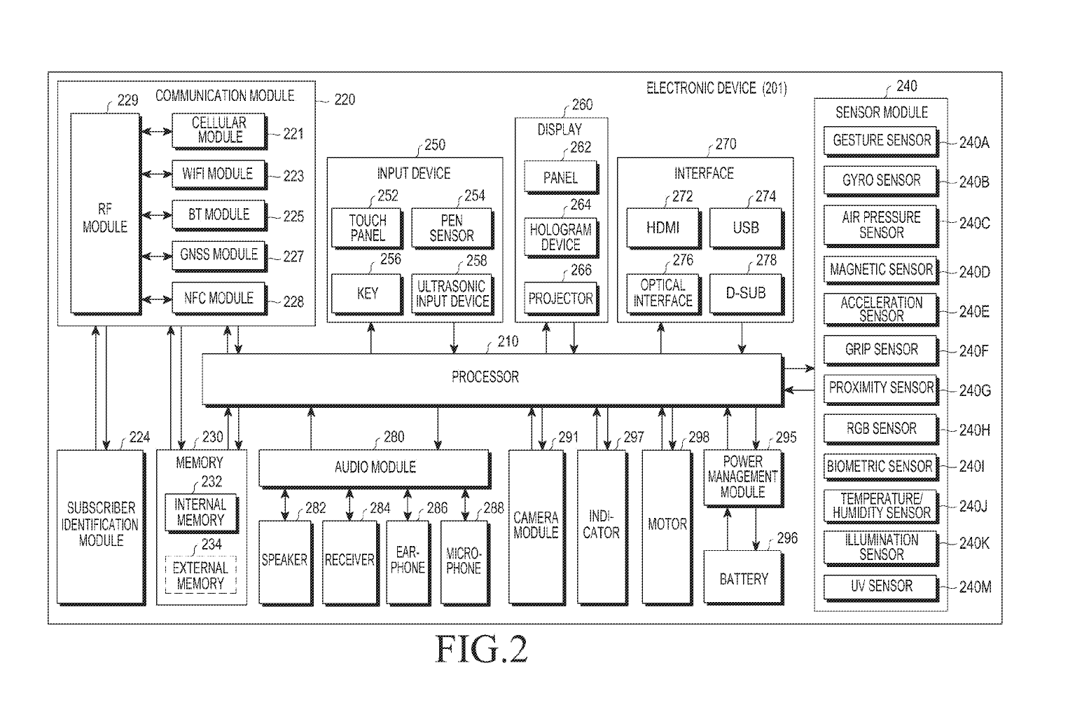

FIG. 2 is a block diagram illustrating an electronic device, according to an embodiment of the present disclosure. An electronic device 201 may include the whole or part of the configuration of, e.g., the electronic device 101 of FIG. 1. The electronic device 201 includes one or more processors (e.g., APs) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control multiple hardware and software components connected to the processor 210 by running, e.g., an operating system or application programs, and the processor 210 may process and compute various data. The processor 210 may be implemented in, e.g., a system on chip (SoC). According to an embodiment of the present disclosure, the processor 210 may further include a graphic processing unit (GPU) and/or an image signal processor. The processor 210 may include at least some (e.g., a cellular module 221) of the components shown in FIG. 2. The processor 210 may load a command or data received from at least one of other components (e.g., a non-volatile memory) on a volatile memory, process the command or data, and store various data in the non-volatile memory.

The communication module 220 may have the same or similar configuration to the communication interface 170 of FIG. 1. The communication module 220 includes, for example, a cellular module 221, a Wi-Fi module 223, a BT module 225, a GNSS module 227, an NFC module 228, and a radio frequency (RF) module 229.

The cellular module 221 may provide voice call, video call, text, or Internet services through, e.g., a communication network. The cellular module 221 may perform identification or authentication on the electronic device 201 in the communication network using the subscriber identification module 224 (e.g., the SIM card). According to an embodiment of the present disclosure, the cellular module 221 may perform at least some of the functions providable by the processor 210. According to an embodiment of the present disclosure, the cellular module 221 may include a communication processor (CP).

The Wi-Fi module 223, the Bluetooth module 225, the GNSS module 227, or the NFC module 228 may include a process for, for example, processing data communicated through the module. At least some (e.g., two or more) of the cellular module 221, the Wi-Fi module 223, the Bluetooth module 225, the GNSS module 227, or the NFC module 228 may be included in a single integrated circuit (IC) or an IC package.

The RF module 229 may communicate data, e.g., communication signals (e.g., RF signals). The RF module 229 may include, e.g., a transceiver, a power amplifier module (PAM), a frequency filter, a low noise amplifier (LNA), or an antenna. According to an embodiment of the present disclosure, at least one of the cellular module 221, the Wi-Fi module 223, the Bluetooth module 225, the GNSS module 227, or the NFC module 228 may communicate RF signals through a separate RF module.

The subscription identification module 224 may include, e.g., a card including a subscriber identification module and/or an embedded SIM, and may contain unique identification information (e.g., an integrated circuit card identifier (ICCID) or subscriber information (e.g., an international mobile subscriber identity (IMSI)).

The memory 230 (e.g., the memory 130 of FIG. 1) includes one or more of an internal memory 232 and an external memory 234. The internal memory 232 may include at least one of, e.g., a volatile memory (e.g., a dynamic random access memory (RAM) (DRAM), a static RAM (SRAM), a synchronous DRAM (SDRAM), etc.) or a non-volatile memory (e.g., a one-time programmable read only memory (ROM) (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD).

The external memory 234 may include a flash drive, e.g., a compact flash (CF) memory, a secure digital (SD) memory, a micro-SD memory, a min-SD memory, an extreme digital (xD) memory, a multi-media card (MMC), or a memory stick. The external memory 234 may be functionally and/or physically connected with the electronic device 201 via various interfaces.

For example, the sensor module 240 may measure a physical quantity or detect an operational state of the electronic device 201, and the sensor module 240 may convert the measured or detected information into an electrical signal. The sensor module 240 includes at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., an red-green-blue (RGB) sensor, a bio sensor 240I, a temperature/humidity sensor 240J, an illumination sensor 240K, or an Ultra Violet (UV) sensor 240M. Additionally or alternatively, the sensing module 240 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the sensing module. According to an embodiment of the present disclosure, the electronic device 201 may further include a processor configured to control the sensor module 240 as part of the processor 210 or separately from the processor 210, and the electronic device 201 may control the sensor module 240 while the processor 210 is in a sleep mode.

The input unit 250 includes, e.g., a touch panel 252, a (digital) pen sensor 254, a key 256, and/or an ultrasonic input device 258. The touch panel 252 may use at least one of capacitive, resistive, infrared, or ultrasonic methods. The touch panel 252 may further include a control circuit. The touch panel 252 may further include a tactile layer and may provide a user with a tactile reaction.

The (digital) pen sensor 254 may include, e.g., a part of a touch panel or a separate sheet for recognition. The key 256 may include, e.g., a physical button, optical key or key pad. The ultrasonic input device 258 may sense an ultrasonic wave generated from an input tool through a microphone 288 to identify data corresponding to the sensed ultrasonic wave.

The display 260 (e.g., the display 160) includes a panel 262, a hologram device 264, and/or a projector 266. The panel 262 may have the same or similar configuration to the display 160 of FIG. 1. The panel 262 may be implemented to be flexible, transparent, or wearable. The panel 262 may also be incorporated with the touch panel 252 in a module. The hologram device 264 may make three dimensional (3D) images (holograms) in the air by using light interference. The projector 266 may display an image by projecting light onto a screen. The screen may be, for example, located inside or outside of the electronic device 201. In accordance with an embodiment of the present disclosure, the display 260 may further include a control circuit to control the panel 262, the hologram device 264, or the projector 266.

The interface 270 includes, e.g., a HDMI 272, a USB 274, an optical interface 276, or a D-subminiature (D-sub) 278. The interface 270 may be included in e.g., the communication interface 170 shown in FIG. 1. Additionally or alternatively, the interface 270 may include a mobile high-definition link (MHL) interface, a secure digital (SD) card/multimedia card (MMC) interface, or infra-red data association (IrDA) standard interface.

The audio module 280 may convert a sound into an electric signal or vice versa, for example. At least a part of the audio module 280 may be included in, e.g., the input/output interface 145 of FIG. 1. The audio module 280 may process sound information input or output through, e.g., a speaker 282, a receiver 284, an earphone 286, or the microphone 288.

The camera module 291 may be a device for capturing still images and videos, and may include, according to an embodiment of the present disclosure, one or more image sensors (e.g., front and back sensors), a lens, an image signal processor (ISP), or a flash such as an LED or xenon lamp.

The power manager module 295 may manage power of the electronic device 201, for example. According to an embodiment of the present disclosure, the power manager module 295 may include a power management Integrated circuit (PMIC), a charger IC, or a battery or gauge. The PMIC may have a wired and/or wireless recharging scheme. The wireless charging scheme may include, e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part (e.g., the processor 210) of the electronic device, including e.g., a booting state, a message state, or recharging state. The motor 298 may convert an electric signal into a mechanical vibration and may generate a vibrational or haptic effect. A processing unit for supporting mobile TV, such as, for example, a GPU may be included in the electronic device 201. The processing unit for supporting mobile TV may process media data conforming to a standard for digital multimedia broadcasting (DMB), digital video broadcasting (DVB), or mediaFlo™.

Each of the aforementioned components of the electronic device may include one or more parts, and a name of the part may vary with a type of the electronic device. The electronic device in accordance with various embodiments of the present disclosure may include at least one of the aforementioned components, omit some of them, or include other additional component(s). Some of the components may be combined into an entity, but the entity may perform the same functions as the components may do.

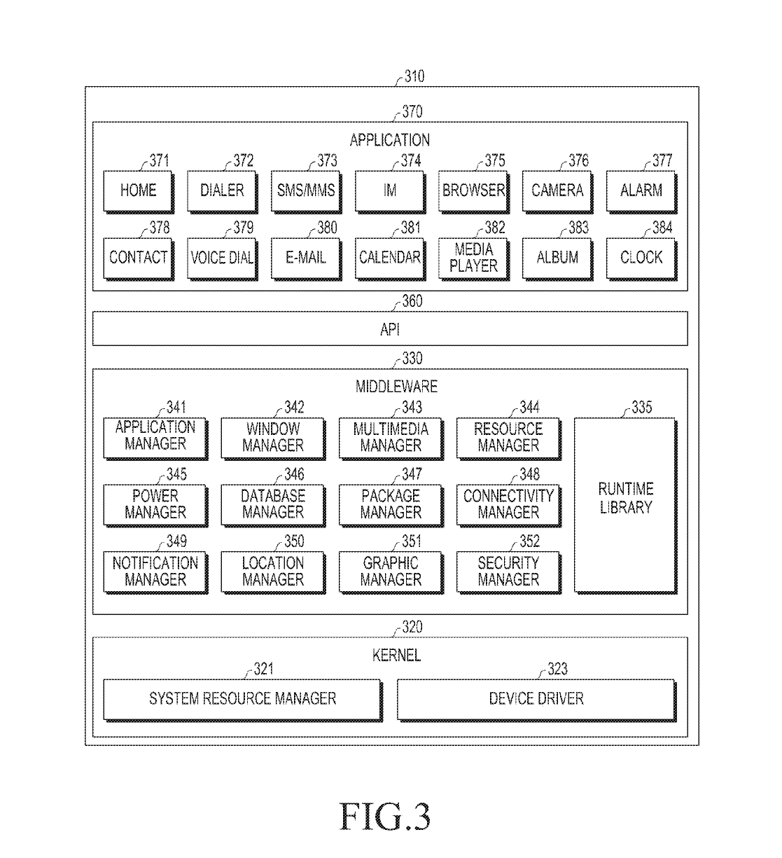

FIG. 3 is a block diagram illustrating a program module, according to an embodiment of the present disclosure. A program module 310 (e.g., the program 140 of FIG. 1) may include an OS controlling resources related to the electronic device (e.g., the electronic device 101 of FIG. 1) and/or various applications (e.g., the application processor 147 of FIG. 1) driven on the operating system.

The program 310 includes, e.g., a kernel 320, middleware 330, an API 360, and/or an application 370. At least a part of the program module 310 may be preloaded on the electronic device or may be downloaded from a server.

The kernel 320 (e.g., the kernel 141 of FIG. 1) includes, e.g., a system resource manager 321 and/or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a Bluetooth driver, a shared memory driver, a USB driver, a keypad driver, a Wi-Fi driver, an audio driver, or an inter-process communication (IPC) driver.

The middleware 330 may provide various functions to the application 370 through the API 360 so that the application 370 may efficiently use limited system resources in the electronic device or provide functions jointly required by applications 370. According to an embodiment of the present disclosure, the middleware 330 (e.g., middleware 143 of FIG. 1) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module used by a compiler in order to add a new function through a programming language while, e.g., the application 370 is being executed. The runtime library 335 may perform input/output management, memory management, or operation on arithmetic functions.

The application manager 341 may manage the life cycle of at least one application of, e.g., the applications 370. The window manager 342 may manage GUI resources used on the screen. The multimedia manager 343 may grasp formats necessary to play various media files and use a codec appropriate for a format to perform encoding or decoding on media files. The resource manager 344 may manage resources, such as source code of at least one of the applications 370, memory or storage space.

The power manager 345 may operate together with, e.g., a basic input/output system (BIOS) to manage battery or power and provide power information necessary for operating the electronic device. The database manager 346 may generate, search, or vary a database to be used in at least one of the applications 370. The package manager 347 may manage installation or update of an application that is distributed in the form of a package file.

The connectivity manager 348 may manage wireless connectivity, such as, for example, Wi-Fi or Bluetooth. The notification manager 349 may display or notify an event, such as an incoming message, appointment, or proximity notification, of the user without interfering with the user. The location manager 350 may manage locational information on the electronic device. The graphic manager 351 may manage graphic effects to be offered to the user and their related user interface. The security manager 352 may provide various security functions necessary for system security or user authentication. According to an embodiment of the present disclosure, when the electronic device (e.g., the electronic device 101 of FIG. 1) has telephony capability, the middleware 330 may further include a telephony manager for managing voice call or video call functions of the electronic device.

The middleware 330 may include a middleware module forming a combination of various functions of the above-described components. The middleware 330 may be provided a specified module per type of the operating system in order to provide a differentiated function. Further, the middleware 330 may dynamically omit some existing components or add new components.

The API 360 (e.g., the API 145 of FIG. 1) may be a set of, e.g., API programming functions and may have different configurations depending on operating systems. For example, one API set may be provided per platform, or two or more API sets may be offered per platform.

The application 370 (e.g., the application processor 147 of FIG. 1) may include one or more applications that may provide functions such as, e.g., a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, or a clock 384, a health-care (e.g., measuring the degree of workout or blood sugar), or provision of environmental information (e.g., provision of air pressure, moisture, or temperature information).

According to an embodiment of the present disclosure, the application 370 may include an information exchanging application supporting information exchange between the electronic device (e.g., the electronic device 101 of FIG. 1) and an external electronic device (e.g., the first and second external electronic devices 102 and 104 of FIG. 1). Examples of the information exchange application may include, but is not limited to, a notification relay application for transferring specific information to the external electronic device, or a device management application for managing the external electronic device.

For example, the notification relay application may include a function for relaying notification information generated from other applications of the electronic device (e.g., the SMS/MMS application, email application, health-care application, or environmental information application) to the external electronic device (e.g., the electronic devices 102 and 104). Further, the notification relay application may receive notification information from, e.g., the external electronic device and may provide the received notification information to the user.

The device management application may perform at least some functions of the external electronic device (e.g., the first or second external electronic device 102 or 104 of FIG. 1) communicating with the electronic device (for example, turning on/off the external electronic device (or some components of the external electronic device) or control of brightness (or resolution) of the display), and the device management application may manage (e.g., install, delete, or update) an application operating in the external electronic device or a service (e.g., call service or message service) provided from the external electronic device.

According to an embodiment of the present disclosure, the application 370 may include an application (e.g., a health-care application of a mobile medical device) designated according to an attribute of the external electronic device (e.g., the first and second external electronic devices 102 and 104 of FIG. 1). According to an embodiment of the present disclosure, the application 370 may include an application received from the external electronic device (e.g., the server 106, the first external electronic device 102, and the second external electronic 104). According to an embodiment of the present disclosure, the application 370 may include a preloaded application or a third party application downloadable from a server. The names of the components of the program module 310 according to the shown embodiment may be varied depending on the type of operating system.

According to an embodiment of the present disclosure, at least a part of the program module 310 may be implemented in software, firmware, hardware, or in a combination of two or more thereof. At least a part of the programming module 310 may be implemented (e.g., executed) by, e.g., a processor (e.g., the processor 210). At least a part of the program module 310 may include, e.g., a module, program, routine, set of instructions, process, or the like for performing one or more functions.

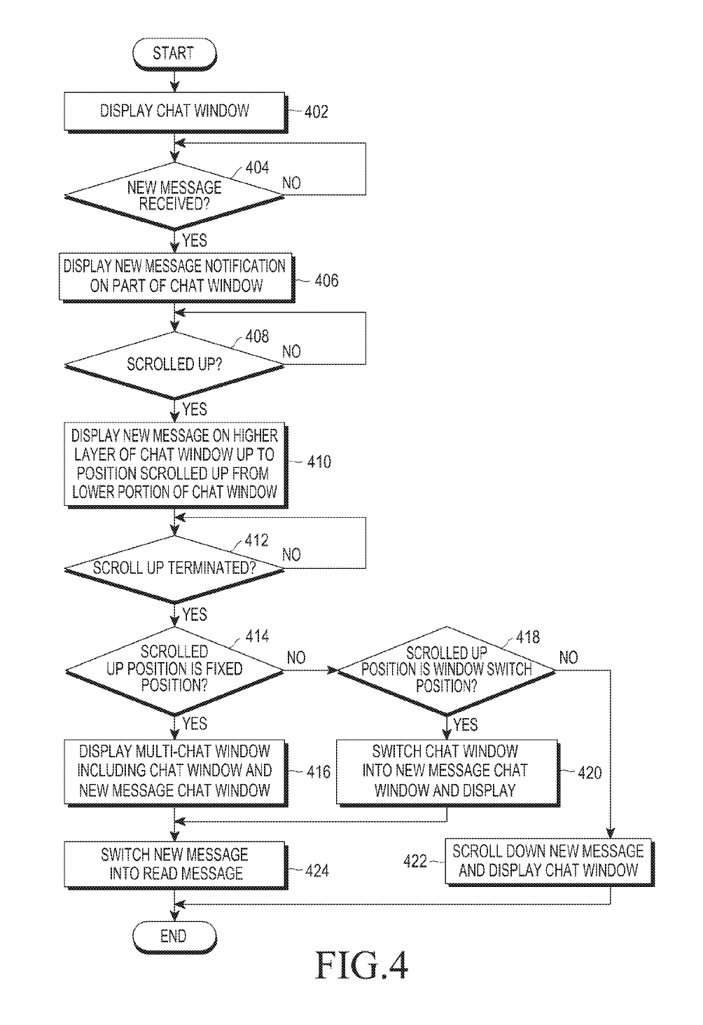

FIG. 4 is a flowchart illustrating an operation of displaying a new message while on chat in an electronic device, according to an embodiment of the present disclosure.

Referring to FIG. 4, the electronic device displays a chat window (or a message window or a first message window), in step 402. According to an embodiment of the present disclosure, the chat window may be a chat window or conversation view and may display messages communicated between the user of the electronic device and at least one or more opposite parties.

The electronic device determines whether a new message is received, in step 404. According to an embodiment of the present disclosure, the electronic device may receive the new message while displaying another message through the chat window. The new message may be a message that is not a message related to the chat window currently in display.

When the new message is received, the electronic device displays a new message notification on a portion of the chat window, in step 406. According to an embodiment of the present disclosure, the electronic device may display the new message notification on a portion of a lower end of the chat window. The new message notification may be displayed in the form of a bar, balloon, floating icon, or a tab on a lower portion of the chat window. The new message notification may be displayed in other various forms or types.

The electronic device determines whether a scroll up event occurs, in step 408. According to an embodiment of the present disclosure, the scroll up event may be generated by the user's operation of touching the display panel and then dragging up (or scrolling up). The electronic device may determine at least one of the length, speed, and position of the scroll up when the scroll up event occurs. A gesture event other than the scroll up event may be used to view the new message. The gesture event may be a sneak peek event. The sneak peek event may be a gesture event for viewing the new message, such as preview or peep.

When the scroll up event occurs, the electronic device displays the new message at the position scrolled up to from a lower portion of the chat window, in step 410. According to an embodiment of the present disclosure, the electronic device may display at least a portion of the new message. The new message may be at least a portion of the text included in the new message or at least a portion of the new chat window (or second message window) including the new message. When displaying the new chat window, and the new message notification on the lower portion of the chat window is touched and dragged up, the electronic device may display the new chat window in such a manner as to expand the new message chat window from the touched position to the dragged position. The length, speed, and position of the expansion of the new message chat window from the touched position to the dragged position may be determined depending on the length, speed, and position of the scroll up. The new message scrolls up, the electronic device may display the scrolled-up new message as read. Even when scrolled up, the electronic device may configured such that the new message chat window is not processed as read or so that even when the new message chat window is scrolled up, it is displayed as read but required to be read again.

In step 412, the electronic device determines whether the scroll up operation is terminated. According to an embodiment of the present disclosure, when a touch release occurs, the electronic device may determine that the scroll up operation is terminated.

When the scroll up operation is terminated, the electronic device determines whether the scrolled-up position is a fixed position, in step 414. According to an embodiment of the present disclosure, the electronic device may determine whether the touch-released position is a predetermined, fixed position. According to an embodiment of the present disclosure, the fixed position may be a predetermined position enabling the expanding new message chat window to be fixed on the display screen and may be a position corresponding to 50% of the area of the display screen.

When the scrolled-up position is the fixed position, the electronic device may display a multi-chat window (or a multi-message window) including the chat window and the new message chat window on the display screen, in step 416. According to an embodiment of the present disclosure, when the new message chat window is expandingly displayed by the scroll up operation while the chat window is on display, and then, the scrolled-up position becomes the fixed position, the electronic device stops the expansion and fixes and displays the same. Accordingly, the multi-chat window including the chat window and the new message chat window may be displayed on the display screen. The electronic device may display back the previous chat window when there is entry of a back key corresponding to the return to the previous by the user while the multi-chat window is on display.

When the scrolled-up position is not the fixed position, the electronic device may determine whether the scrolled-up position is a window switch position, in step 418. According to an embodiment of the present disclosure, the electronic device may determine whether the touch-released position is the predetermined window switch position. The window switch position may be a predetermined position on the display screen and may be a predetermined position allowing the chat window to switch to the new message window.

When the scrolled-up position is the window switch position, the electronic device switches the chat window into the new message chat window and displays the same, in step 420. When the new message chat window is expandingly displayed by the scroll up operation while the chat window is on display, and then, the scrolled-up position becomes the window switch position, the electronic device switches the chat window into the new message chat window and display the same. When a user input is received for going back to the previous step after there is the switch to the new message chat window, the electronic device may terminate the new message chat window and display back the previous chat window. Here, the user input for going back to the previous step may be a predetermined back key.

Unless the scrolled-up position is the fixed position or window switch position, the electronic device allows the new message to disappear in a scroll down manner and displays the chat window, in step 422. According to an embodiment of the present disclosure, unless the touch released position is the fixed position or the window switch position, the electronic device may stop displaying the new message and display back the original chat window. For example, allowing the new message to disappear in the scroll down manner may be a scheme by which the new message is displayed in a sneak peek manner and then disappears.

The electronic device switches the new message into a read message in step 424, after displaying the multi-chat window in step 416 or switching the chat window into the new message chat window in step 420.

As set forth above, according to an embodiment of the present disclosure, notification, selection, and checking of a new message may be done on the chat window, and thus, the user may quickly check a new message and go back to the chat without several steps of screen switching or page shift for new message check while messaging on the chat window.

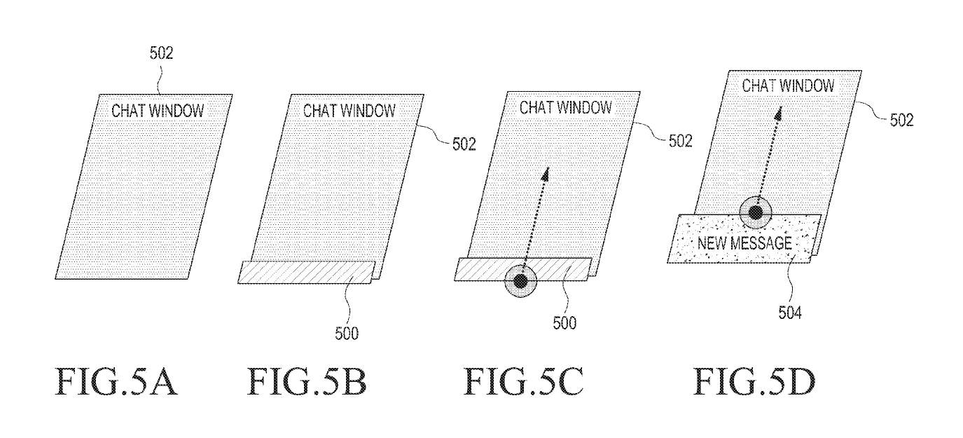

FIGS. 5A-5D are diagrams illustrating contention window layers, according to an embodiment of the present disclosure. Referring to FIG. 5A, when a new message is received while a chat window 502 is displayed, a new message notification 500 is displayed on a higher layer (e.g., foreground) of the chat window 502, as shown in FIG. 5B. When the new message notification 500 is selected and scrolled up, as shown in FIG. 5C, the electronic device expands and displays the area where the new message is displayed to a position scrolled up in the higher layer of the chat window 502, as shown in FIG. 5D. According to an embodiment of the present disclosure, at least a portion of the new message may be displayed on the area where the new message is displayed. The portion of the new message may include at least a portion of the text included in the new message or at least a portion of the new chat window including the new message.

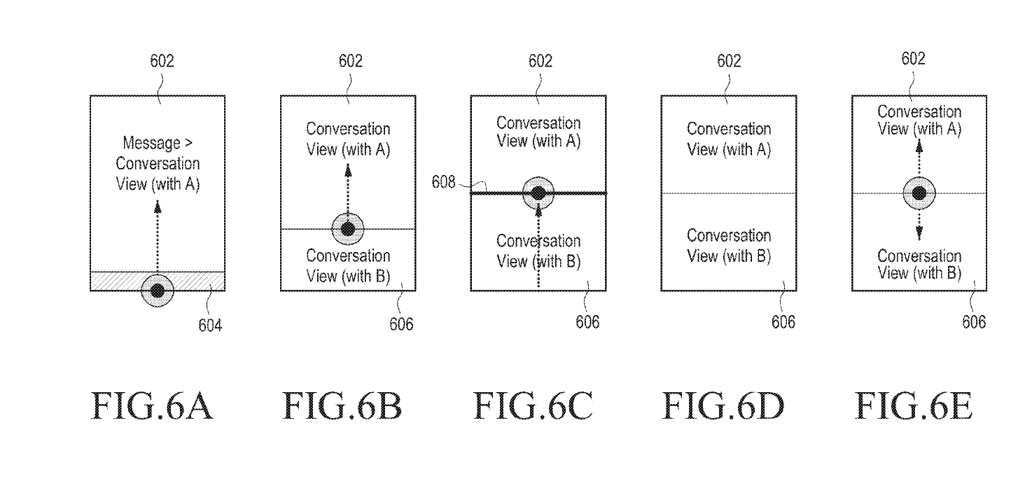

FIGS. 6A-6E are diagrams illustrating a process of displaying a multi-chat window including a chat window and a new message chat window upon reception of a new message on the chat window, according to an embodiment of the present disclosure.

Referring to FIG. 6A, when a new message notification 604 is displayed by the reception of a new message from party B while displaying chat window A 602, where a chat with party A is performed, the electronic device displays the new message notification 604 on a lower portion of the chat window. Referring to FIG. 6B, when the new message notification 604 is touched and dragged up by the user to generate a scroll up event, the electronic device expands and displays chat window B 606 including the new message received from party B up to the scrolled-up position. Referring to FIG. 6C, when the scrolled-up position reaches a predetermined fixed position 608, the electronic device does not expand the chat window B 606 including the new message any further and displays the same in a fixed manner. Here, the fixed position 608 is a predetermined position on the display screen and may be a predetermined position allowing the expanding new message chat window to be fixed. Referring to FIG. 6D, with the chat window B 606 fixed, the electronic device displays a multi-chat window including the chat window A 602 and the chat window B 606 on the display screen. Referring to FIG. 6E, the electronic device adjusts the area of the chat window A 602 and the chat window B 606 according to the user's scroll up/down operation with respect to the border between the chat window A 602 and the chat window B 606 while the multi-chat window including the chat window A 602 and the chat window B 606 are on display.

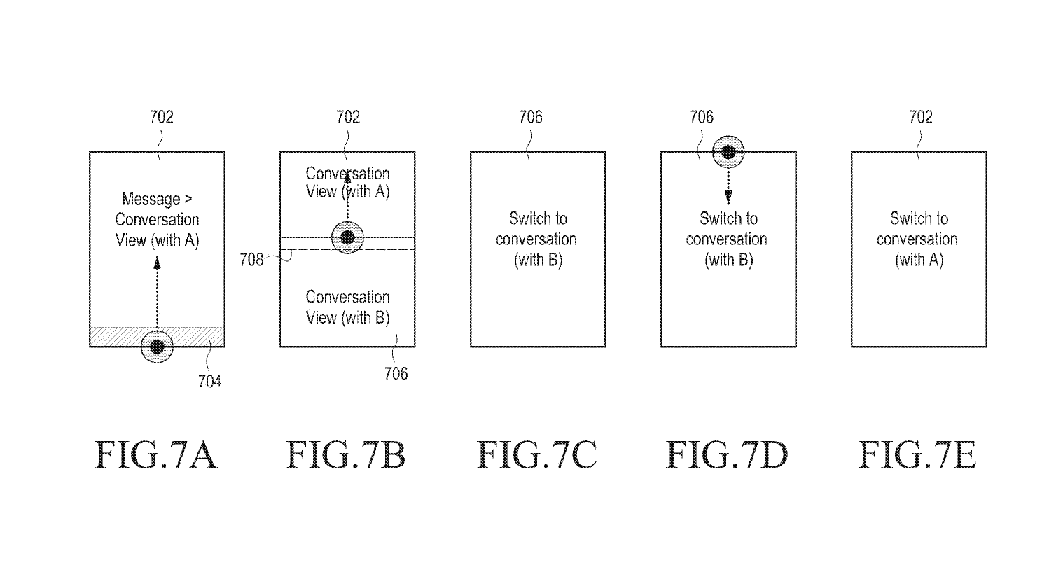

FIGS. 7A-7E are diagrams illustrating a process in which a chat window switches to a new message chat window upon reception of a new message on the chat window, according to an embodiment of the present disclosure.

Referring to FIG. 7A, when a notification 704 for a new message from party B is displayed while displaying a chat window A 704, where a chat with party A is performed, on the display screen, the electronic device displays the new message notification 704 on a lower portion of the chat window. Referring to FIG. 7B, when the new message notification 704 is touched and dragged up by the user to generate a scroll up event, the electronic device expands and displays the chat window B 706 including the new message received from party B up to the scrolled-up position. The electronic device determines whether the scrolled-up position goes beyond a predetermined window switch position 708. Referring to FIG. 7C, when the scrolled-up position goes beyond the predetermined window switch position 708, the electronic device switches the chat window A 702 into the chat window B 706 and displays the same. Referring to FIG. 7D, when a scroll down event is generated by the user from the top of the chat window B 706 down, the electronic device switches the chat window B 706 back into the chat window A 702 and display the same as shown in FIG. 7E.

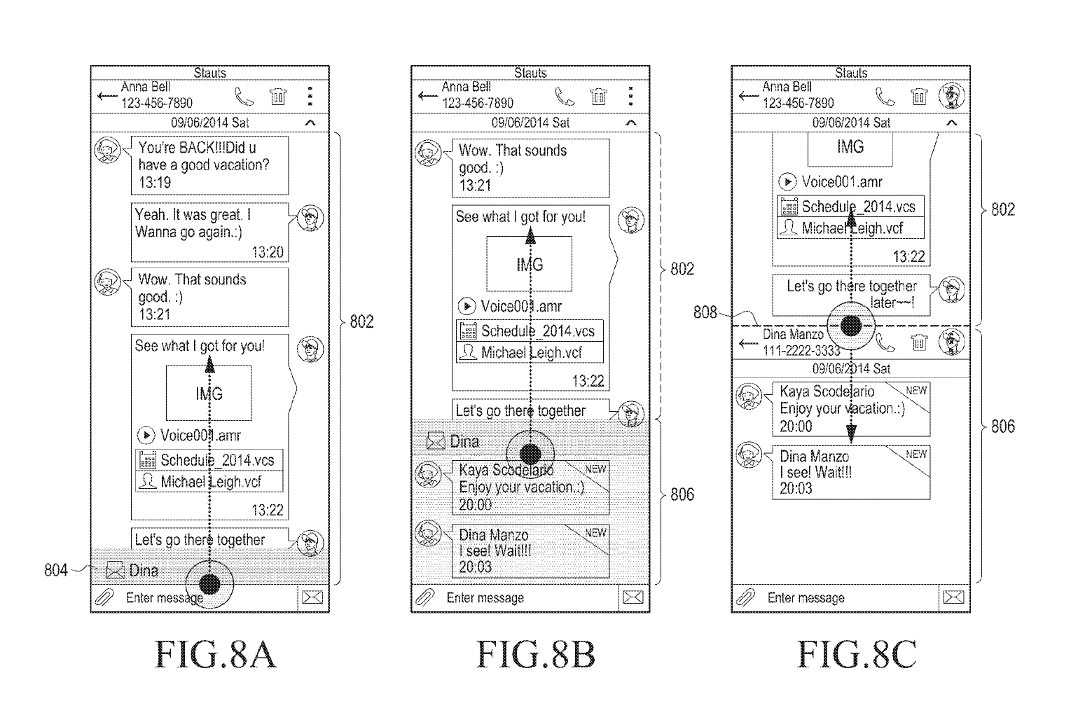

FIGS. 8A-8C are diagrams illustrating a scheme of displaying a new message chat window on a chat window, according to an embodiment of the present disclosure.

Referring to FIG. 8A, the electronic device displays a notification 804 for a new message from “Dina” while a chat window 802 with “Anne Bell” is on the display. Referring to FIG. 8B, when the new message notification 804 is touched and dragged up by the user to generate a scroll up event, the electronic device displays the chat window 806 including the new message received from “Dina” up to the scrolled-up position. According to an embodiment of the present disclosure, the electronic device displays chat window 806 to gradually get brighter as scrolled up or to gradually turn from a transparent state to an opaque state as scrolled up. The electronic device may apply a shape or color (e.g., a Mickey Mouse shape or color) corresponding to a preset theme (e.g., a Disney® theme) to the chat window 806 including the new message and display the same. Referring to FIG. 8C, when the scrolled-up position reaches a predetermined fixed position 808, the electronic device fixes and displays the chat window 806 with “Dina.” Here, the fixed position 808 is a predetermined position on the display screen and may be a predetermined position allowing the expanding new message chat window to be fixed. With the chat window 806 with “Dina” is fixed, the electronic device displays a multi-chat window including the chat window 802 with “Anne Bell” and the chat window 806 with “Dina” on the display screen. The area of the multi-chat window including the chat window 802 with “Anne Bell” and the chat window 806 with “Dina” may be adjusted by the user's scroll up/down operation with respect to the border between the chat windows while the multi-chat window is displayed.

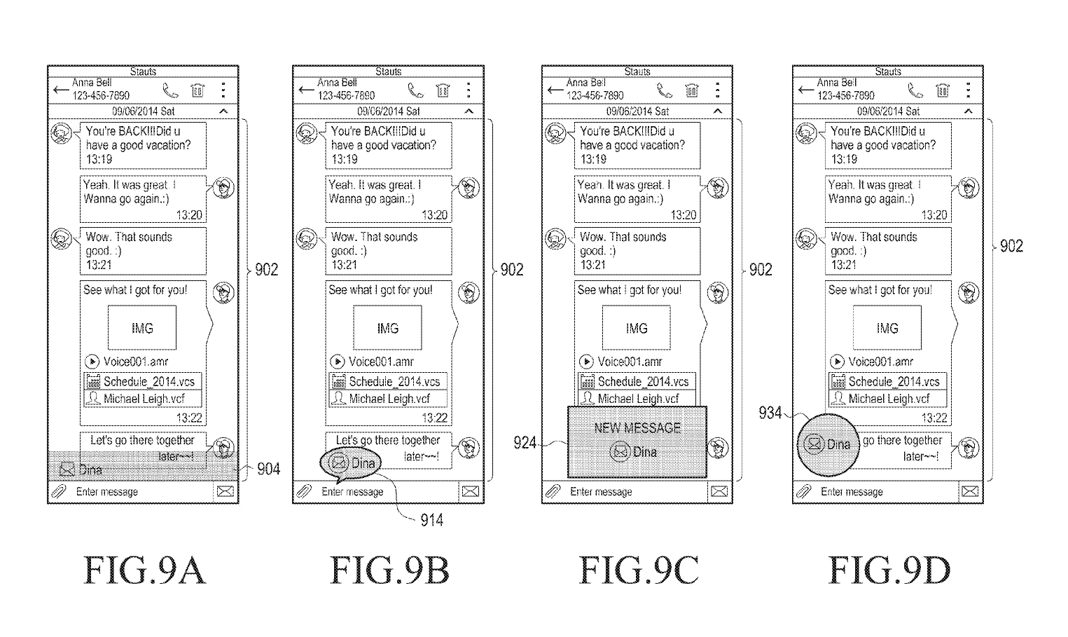

FIGS. 9A-9D are diagrams illustrating a scheme of notifying a new message, according to an embodiment of the present disclosure.

Referring to FIG. 9A, upon reception of a new message while displaying a chat window 902, the electronic device displays a new message notification on a lower portion of the chat window 902 in the form of a bar 904. Referring to FIG. 9B, the electronic device displays the new message notification on the lower portion of the chat window 902 in the form of a balloon 914. Referring to FIG. 9C, the electronic device displays the new message notification on the lower portion of the chat window 902 in the form of a floating icon 924 (e.g., a pop-up window). Referring to FIG. 9D, the electronic device displays the new message notification on the lower portion of the chat window 902 in the form of a tab 934.

Since the new message notification may be displayed in various forms or types as described above, various reception notification selection schemes may apply. According to an embodiment of the present disclosure, when the new message notification is in the form of the bar 904, the reception notification selection scheme by the user may be a scroll up operation. When the new message notification is in the form of the balloon 914 or the floating icon 924, the reception notification selection scheme by the user may be a pinch zoom operation. When the new message notification is in the form of the tab 934, the reception notification selection scheme by the user may be a touch or double-touch operation.

The electronic device may receive a plurality of new messages while displaying the chat window and may display one or more notifications for the received new messages in various manners.

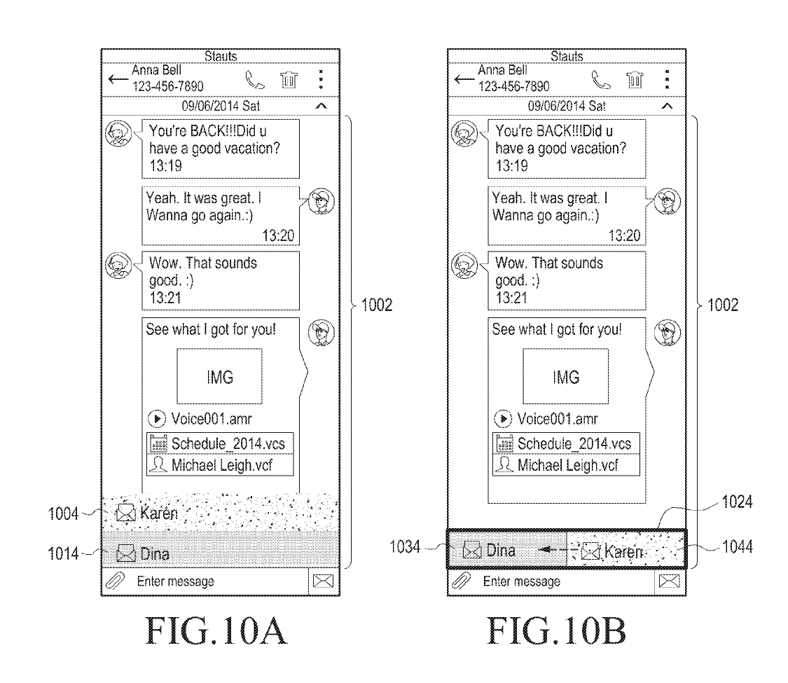

FIGS. 10A-10B, 11A-11C, 12A-12C, and 13A-13C are diagrams illustrating a scheme of notifying new messages when a plurality of new messages are received, according to an embodiment of the present disclosure.

Referring to FIG. 10A, upon reception of a new message from “Dina” and a new message from “Karen” while displaying a chat window 1002 with “Anne Bell”, the electronic device displays a “Karen” new message reception notification bar 1004 and a “Dina” new message reception notification bar 1014 on a lower portion of the chat window 1002 with “Anne Bell” in different colors and in a bar-stack form. When one of the new message reception notification bars on the bar stack is selected, the electronic device may display the selected new message. Referring to FIG. 10B, upon reception of a new message from “Dina” and a new message from “Karen” while displaying a chat window 1002 with “Anne Bell,” the electronic device assigns a notification area 1024 on a lower portion of the chat window 1002 with “Anne Bell”, and displays a “Karen” new message reception notification message 1034 and a “Dina” new message reception notification message 1044, as if the messages 1034 and 1044 flow in a predetermined direction. When one of the new message reception notification messages is selected, the electronic device may display the selected new message.

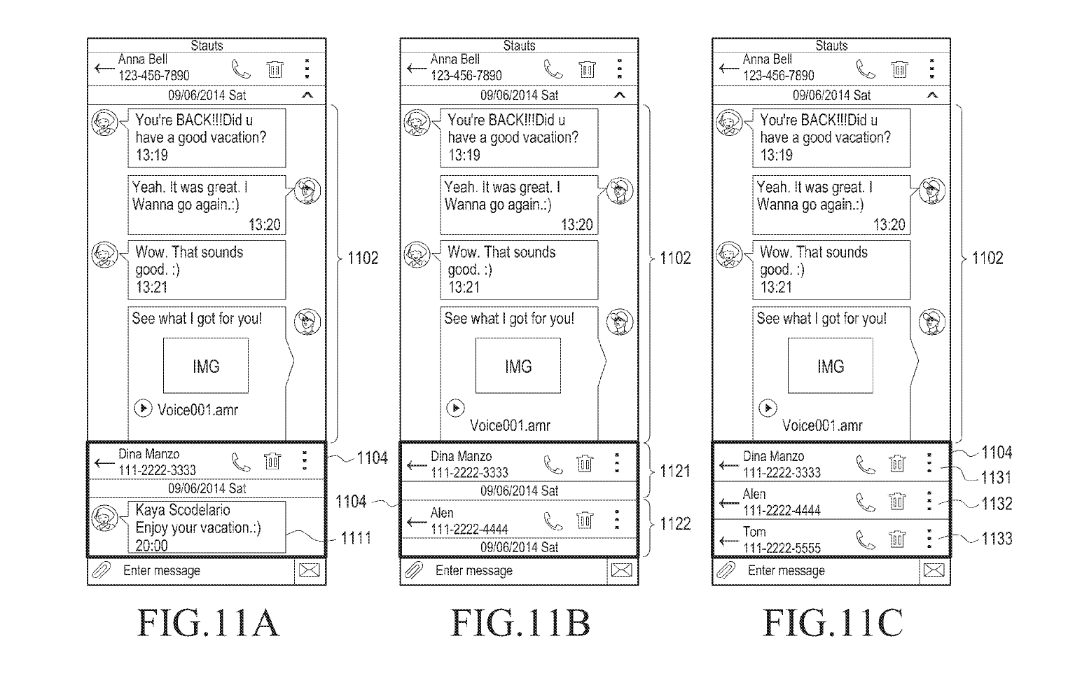

Referring to FIGS. 11A to 11C, the electronic device assigns an area that is large enough to view one simple message on a chat window 1102 as a new message reception notification area 1104. Upon reception of one new message, the electronic device displays a received message 1111 on the whole new message reception notification area 1104 as shown in FIG. 11A. Upon reception of two new messages, the electronic device displays the received two messages 1121 and 1122 on the new message reception notification area 1104, as shown in FIG. 11B. Upon reception of three new messages, the electronic device displays the received three messages 1131, 1132, and 1133 on the new message reception notification area 1104 as shown in FIG. 11C. According to an embodiment of the present disclosure, as the number of new message reception notification messages in the new message reception notification area 1104 increases, the amount of displayed information on each new message reception notification message decreases. For example, when one message 1111 is displayed on the new message reception notification area 1104, the recipient information and reception date and part of the received message may be displayed whereas, when two messages 1121 and 1122 are displayed on the new message reception notification area 1104, only the recipient information and reception date may be displayed. Further, when three messages 1131, 1132, and 1133 are displayed on the new message reception notification area 1104, only the recipient information may be displayed.

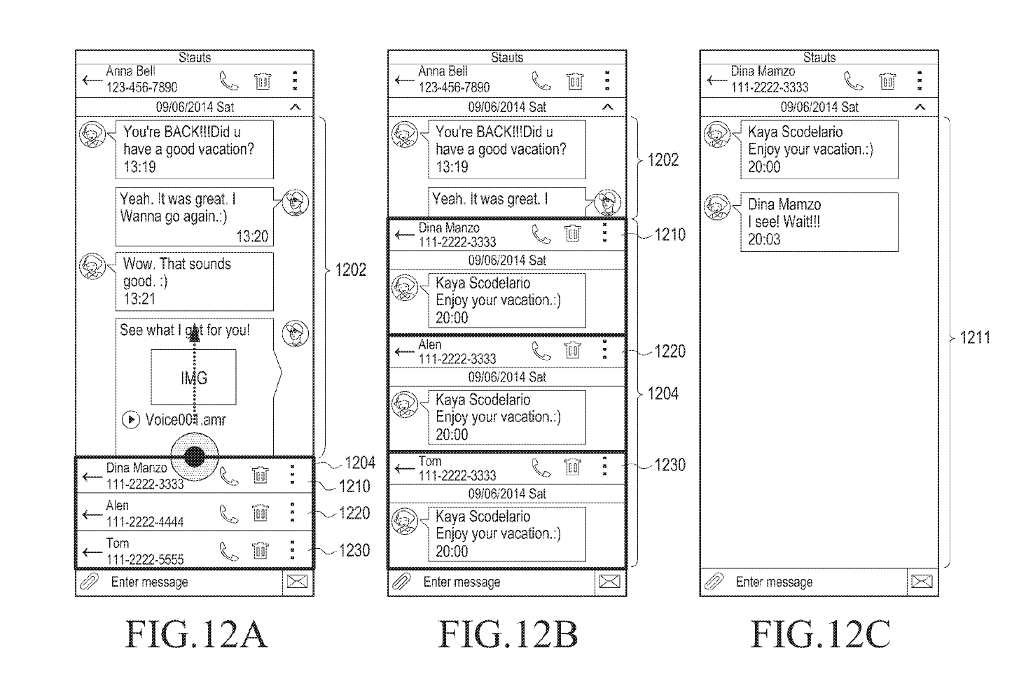

Referring to FIGS. 12A-12C, when a plurality of new message reception notifications are displayed on a new message reception notification area 1204 displayed on a lower portion of a chat window 1202, the electronic device receives a new message reception notification area 1204 expand event. When three new message notifications 1210, 1220, and 1230 are displayed on the new message reception notification area 1204 as shown in FIG. 12A, and a new message reception notification area 1204 expand event is received, such as a scroll up event, the electronic device expands and display the new message reception notification area 1204 as shown in FIG. 12B and gradually expands and displays the three new message notifications 1210, 1220, and 1230 in the new message reception notification area 1204. Upon selection of any one of the expanded new message notifications 1210, 1220, and 1230, the electronic device displays a chat window 1211 corresponding to the selected new message notification 1210, as shown in FIG. 12C.

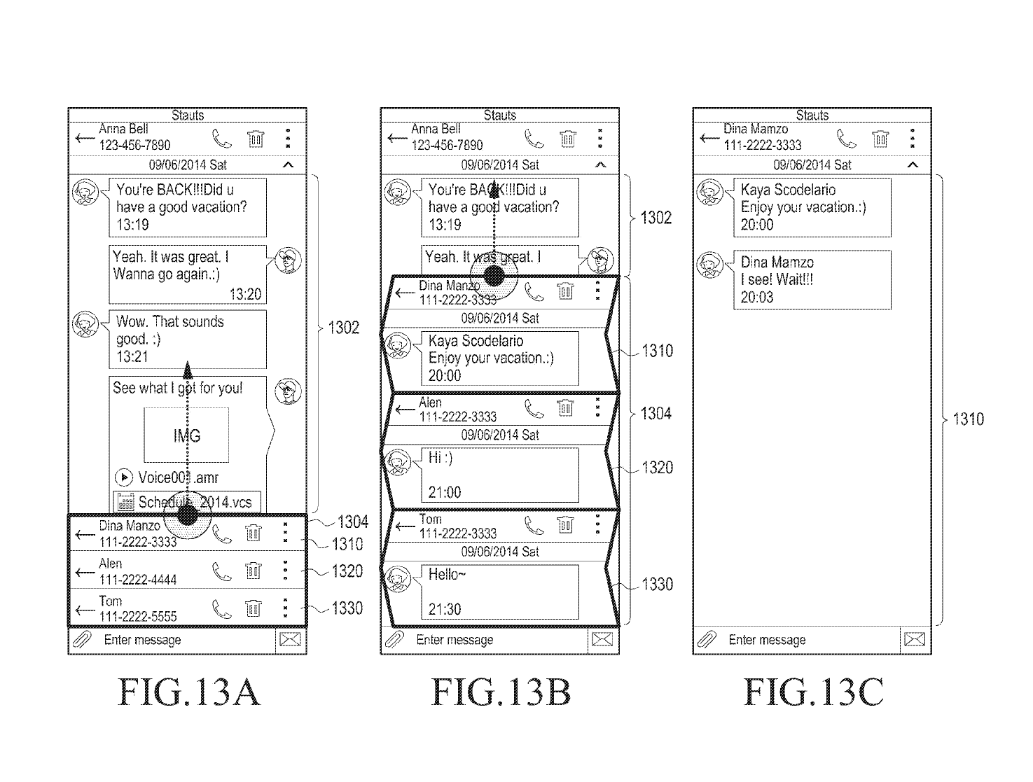

Referring to FIGS. 13A-13C, when three new message notifications 1310, 1320, and 1330 are displayed on a new message reception notification area 1304, as shown in FIG. 13A, and a new message reception notification area 1304 expand event is received, such as a scroll up event, the electronic device expands and displays the new message reception notification area 1304, as shown in FIG. 13B and gradually expands the three new message notifications 1310, 1320, and 1330 in the new message reception notification area 1304 so that the notifications 1310, 1320, and 1330 expands like an accordion does and displays the same. Upon selection of any one of the new message notifications 1310, 1320, and 1330 expanded like an accordion, the electronic device displays a chat window 1311 corresponding to the selected new message notification 1310, as shown in FIG. 13C.

According to an embodiment of the present disclosure, when a new message includes an image, the electronic device may apply a portion of the image as a background image of a new message reception notification or include the same, as a thumbnail, in a new message reception notification. When the new message chat window has predetermined attributes (e.g., background image, background color, or font), the electronic device may apply the attributes of the new message chat window to a new message reception notification and display the same.

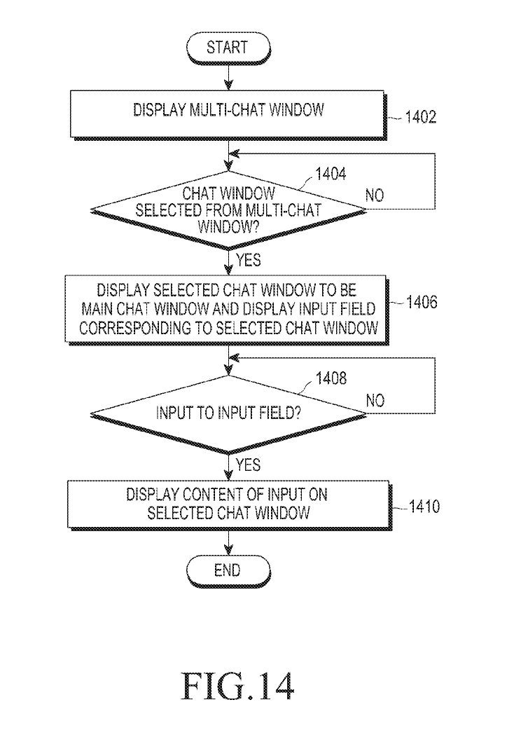

FIG. 14 is a flowchart illustrating an input operation on each chat window while a multi-chat window is displayed, according to an embodiment of the present disclosure.

Referring to FIG. 14, the electronic device displays a multi-chat window, in step 1402. According to an embodiment of the present disclosure, the electronic device may display two or more chat windows on the display screen.

In step 1404, the electronic device determines which one of the multi-chat windows is selected. According to an embodiment of the present disclosure, the electronic device may determine that, when any one of the multi-chat windows is touched or double-touched by the user, the chat window is selected.

In step 1406, the electronic device displays the selected chat window to be a main chat window and displays an input field corresponding to the selected chat window. According to an embodiment of the present disclosure, the electronic device may display the selected chat window on an upper portion, lower portion, left portion, right portion, or a middle portion of the display screen so that the selected chat window is the main chat window, and may display the input field corresponding to the selected chat window on any one of the upper, lower, left, and right portion of the selected chat window.

In step 1408, the electronic device determines whether there is an input to the input field corresponding to the selected chat window. When there is an input to the input field corresponding to the selected chat window, the electronic device displays the inputted content on the selected chat window, in step 1410.

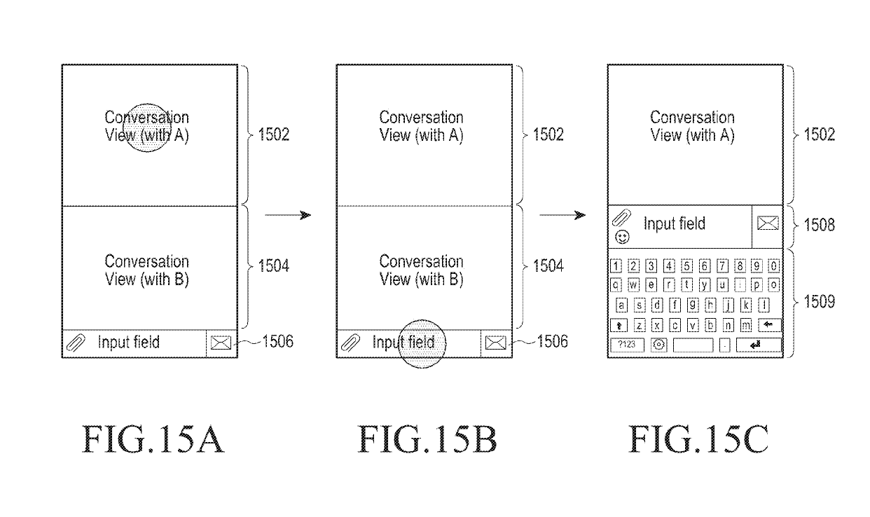

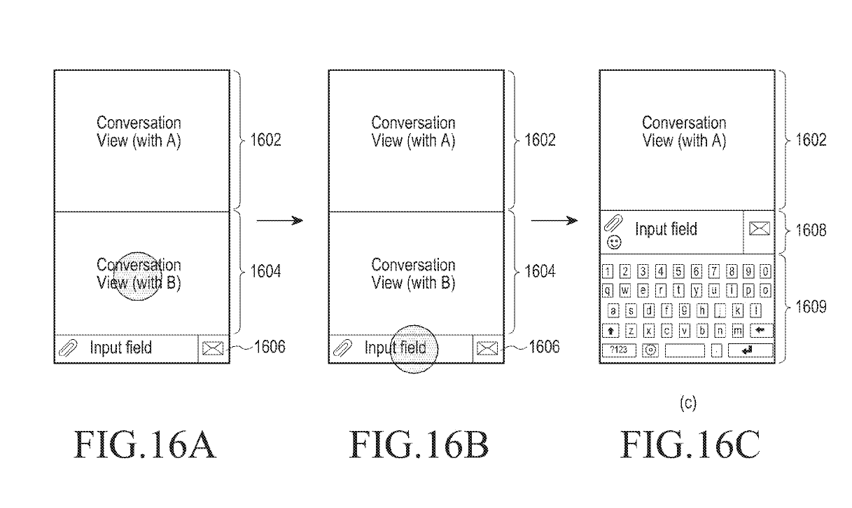

FIGS. 15A-15C and 16A-16C are diagrams illustrating an input operation on each chat window while a multi-chat window is displayed, according to an embodiment of the present disclosure.

Referring to FIG. 15A, the electronic device displays a multi-chat window including chat window A 1502 with party A and chat window B 1504 with party B, and displays an input field 1506 on a lower portion of the multi-chat window. The electronic device receives selection of one of the multi-chat windows, e.g., the chat window A 1502 or the chat window B 1504, according to reception of a touch event by the user's touch operation. Referring to FIG. 15B, the electronic device determines whether the input field 1506 is selected after the chat window A 1502 is selected. When the chat window A 1502 is selected, and then, the input field 1506 is selected, the electronic device displays the selected chat window A 1502 to be a main chat window, as shown in FIG. 15C and displays the input field 1508 corresponding to the selected chat window A 1502 on a lower portion of the selected chat window A 1502. A keypad 1509 for entry to the input field 1508 may also be displayed.

Referring to FIG. 16A, the electronic device receives a selection of a chat window B 1604 according to a user's touch operation while the multi-chat window including a chat window A 1602 and the chat window 1604 are displayed on the display screen. The electronic device receives a selection of an input field 1606 while chat window B 1604 is selected, as shown in FIG. 16B. When chat window B 1604 is selected, and then, the input field 1606 is selected, the electronic device displays the selected chat window B 1604 on an upper portion of the display screen to be a main chat window, as shown in FIG. 16C, and displays the input field 1608 corresponding to the selected chat window B 1604 on a lower portion of the selected chat window B 1604. A keypad 1609 for entry to the input field 1608 is also displayed.

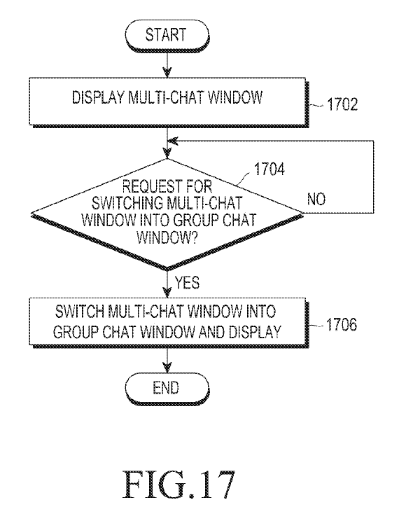

FIG. 17 is a flowchart illustrating an operation of switching a multi-chat window into a group chat window while the multi-chat window is displayed, according to an embodiment of the present disclosure.

Referring to FIG. 17, the electronic device displays a multi-chat window, in step 1702. According to an embodiment of the present disclosure, the electronic device may display two or more chat windows on the display screen.

In step 1704, the electronic device determines whether a request is received for switching the multi-chat window into a group chat window (or a group message window). According to an embodiment of the present disclosure, the electronic device may receive a user input for switching chat windows of the multi-chat window into a single group chat window. The user input for switching the chat windows of the multi-chat window into a single group chat window may include, e.g., a zigzag input, a pinch-out input, or other various types of input. The zigzag input may be an input of a type in which a touch is made and is then moved in a zigzag pattern. The pinch-out input may be an input of a type in which two fingers spread widely are put together to pinch.

Upon reception of a request for switching the multi-chat window into the group chat window, the electronic device switches the multi-chat window into the group chat window and displays the same, in step 1706.

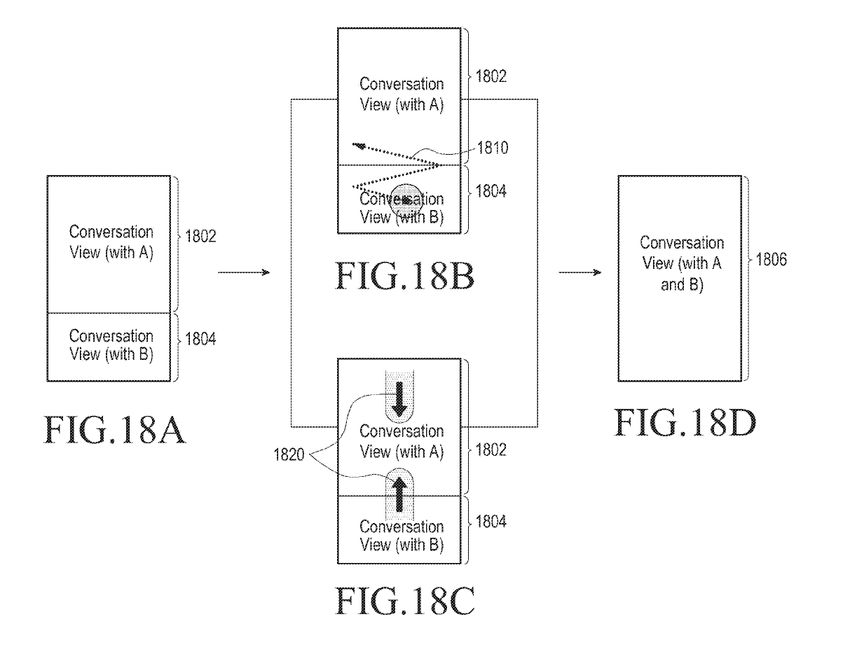

FIGS. 18A-18D are diagrams illustrating an operation of switching a multi-chat window into a group chat window, according to an embodiment of the present disclosure.

Referring to FIG. 18A, the electronic device receives a user input for switching into a group chat window while displaying a multi-chat window including a chat window A 1802 and a chat window 1804 on the display screen. Upon reception of a zigzag input 1810 from chat window B 1804 to chat window A 1802, as shown in FIG. 18B or a pinch-out input 1820, where chat window A 1802 and chat window B 1804 are touched and pinched out by two fingers, respectively, as shown in FIG. 18C, the electronic device determines that there is a user input for switching chat window A 1802 and chat window B 1804 into a group chat window. Upon reception of the user input for switching into the group chat window, the electronic device displays the group chat window 1806 including all of the participants of the chat window A 1802 and the chat window B 1804, as shown in FIG. 18D.

According to an embodiment of the present disclosure, upon reception of a plurality of new messages while a current chat window is displayed, the electronic device may combine the current chat window and a new message chat window, corresponding to at least one new message selected from the plurality of new messages, into the group chat window. Further, when combining the at least one new message chat window and the current chat window into the group chat window, the electronic device may add a new party for the chat.

According to an embodiment of the present disclosure, upon reception of a plurality of new messages while the current chat window is displayed, the electronic device may combine new messages of the same type and display a new message notification. For example, the electronic device may gather new messages having the same message type depending on whether the data type of the received new messages is text, an image, or moving picture, and may display one new message notification. Further, when the messages are sent from the same sender, the electronic device may combine the new messages of the same sender and display one new message notification.

According to an embodiment of the present disclosure, the electronic device may receive a plurality of new messages while displaying a chat window through an integrated messaging application. The integrated messaging application may be an application that may communicate messages following various message transmission protocols, such as, for example, SMS, MMS, IM, or email. Upon reception of a plurality of new messages while displaying a chat window through the integrated messaging application, the electronic device may combine new messages of the same transmission protocol and display the same on one new message chat window. For example, the electronic device may gather SMS transmission protocol-based new messages and display them on one new message chat window, or may display together MMS transmission protocol-based new messages on one new message chat window, IM transmission protocol-based new messages on one new message chat window, or email transmission protocol-based new messages on one new message chat window. Further, the electronic device may simultaneously transmit messages to senders having sent new messages of the same transmission protocol, or may combine the senders having sent the new messages of the same transmission protocol to create one group chat window. Further, when the same sender transmits a plurality of messages of different transmission protocols using a plurality of applications, the electronic device may combine the plurality of messages of the different transmission protocols sent from the sender and display the same on one new message chat window.

Further, according to an embodiment of the present disclosure, upon reception of a plurality of new messages while displaying a chat window through the integrated messaging application, the electronic device may select new messages from different senders, which have different transmission protocols, and create a group chat window. When sending messages on the group chat window with different senders and using different transmission protocols, the electronic device may convert the messages into the respective transmission protocols of the senders and send the same. For example, when the electronic device intends to send an IM message on the group chat window, and some of the participants of the group chat window cannot receive the IM message but can receive an MMS message, the electronic device may convert the IM message into an MMS message and send the converted MMS message to the participants.

Further, according to an embodiment of the present disclosure, when the electronic device intends to allow the participants of the group chat window to be unknown when sending messages on the group chat window, the electronic device may send messages to the participants of the group chat window through their respective individual chat windows. For example, when the electronic device receives respective messages from users A, B, and C on the group chat window, and allows users A, B, and C to be unknown for chatting on the group chat window, the electronic device may send respective reply messages to the users A, B, and C through the individual chat windows for users A, B, and C in the same transmission protocol as that used when each user has sent his message.

Further, according to an embodiment of the present disclosure, the electronic device may identify the respective contact information items of the participants of the group chat window when sending messages on the group chat window, and when there is a common message transmission protocol available for all of the participants, the electronic device may recommend the common message transmission protocol for the users or may transmit messages using the common message transmission protocol.

Each of the aforementioned components of the electronic device may include one or more parts, and a name of the part may vary with a type of the electronic device. The electronic device, in accordance with embodiments of the present disclosure, may include at least one of the aforementioned components, omit some of them, or include additional component(s). Some of the components may be combined into an entity, but the entity may perform the same functions as the components may do.

The term “module” may refer to a unit including one of hardware, software, and firmware, or a combination thereof. The term “module” may be interchangeably used with the terms “unit,” “logic,” “logical block,” “component,” or “circuit.” A module may be a minimum unit or part of an integrated component. A module may be a minimum unit or part of performing one or more functions. A module may be implemented mechanically or electronically. For example, a module may include at least one of application specific integrated circuit (ASIC) chips, field programmable gate arrays (FPGAs), or programmable logic arrays (PLAs) that perform some operations, which have already been known or will be developed in the future.

According to an embodiment of the present disclosure, at least a part of the device (e.g., modules or their functions) or method (e.g., operations) may be implemented as instructions stored in a computer-readable storage medium e.g., in the form of a program module. The instructions, when executed by a processor (e.g., the processor 120 of FIG. 1), may enable the processor to carry out a corresponding function. The computer-readable storage medium may be, for example, the memory 130 of FIG. 1.

The computer-readable storage medium may include a hardware device, such as hard discs, floppy discs, and magnetic tapes (e.g., a magnetic tape), optical media such as compact disc ROMs (CD-ROMs) and DVDs, magneto-optical media such as floptical disks, ROMs, RAMs, flash memories, and/or the like. Examples of the program instructions may include not only machine language codes but also high-level language codes that are executable by various computing means using an interpreter. The aforementioned hardware devices may be configured to operate as one or more software modules to carry out embodiments of the present disclosure, and vice versa.

According to an embodiment of the present disclosure, a storage medium stores a message display program that, on an electronic device, may display a new message reception notification on a chat window by a message application, and when a gesture event occurs within a predetermined area on a display screen corresponding to the new message reception notification, displays the content of the new message for a predetermined time.

Modules or programming modules, in accordance with embodiments of the present disclosure, may include at least one or more of the aforementioned components, omit some of them, or further include additional components. Operations performed by modules, programming modules, or other components, in accordance with embodiments of the present disclosure, may be carried out sequentially, simultaneously, repeatedly, or heuristically. Furthermore, some of the operations may be performed in a different order, omitted, or include other additional operation(s).

While the disclosure has been shown and described with reference to certain embodiments thereof, it will be understood by those skilled in the art that various changes in form and detail may be made therein without departing from the spirit and scope of the disclosure as defined by the appended claims.

What is claimed is:

1. An electronic device, comprising:
a communication module;
a display;
a memory; and
a processor configured to display a reception notification for a new message from a second person on a first message window including messages exchanged between a user and a first person on a screen of the display, and display at least a portion of a second message window including the new message for a predetermined time on the screen when a gesture event detected on the reception notification occurs in a predetermined area of the screen.

2. The electronic device of claim 1, wherein the predetermined gesture event is a scroll up event, and wherein the processor is further configured to display a multi-message window including the first message window and the second message window, when the scroll up event reaches a predetermined fixed position on the screen.

3. The electronic device of claim 2, wherein the processor is further configured to switch the first message window to the second message window, when the scroll up event reaches a predetermined window switch position on the screen.

4. The electronic device of claim 3, wherein the processor is further configured to display the first message window, when a key input is detected corresponding to returning to a previous message window.

5. The electronic device of claim 1, wherein the processor is further configured to display the at least a portion of the second message window on a higher layer of the first message window.

6. The electronic device of claim 1, wherein the reception notification is displayed on a lower portion of the first message window in the form of one of a bar, a balloon, a floating icon, and a tab.

7. The electronic device of claim 1, wherein the processor is further configured to, display a plurality of new message reception notifications on the first message window, when a plurality of new messages are received.

8. The electronic device of claim 6, wherein the processor is further configured to, when a plurality of new messages are received, and the predetermined area is selected, expand and display a plurality of new message windows corresponding to a plurality of new message notifications in a spreading manner.

9. The electronic device of claim 2, wherein the processor is further configured to, when one of the first message window and the second message window is selected from the multi-message window, display the selected message window as a main message window and display an input field corresponding to the selected message window.

10. The electronic device of claim 2, wherein the processor is further configured to, when a request for switching the multi-message window into a group message window is detected, switch the multi-message window into the group message window and display the group message window.

11. A method for displaying a message by an electronic device, the method comprising:
displaying a reception notification for a new message from a second person on a first message window including messages exchanged between a user and a first person on a display screen of the electronic device; and
displaying at least a portion of a second message window including the new message for a predetermined time on the display screen, when a predetermined gesture event detected on the reception notification occurs in a predetermined area of the display screen.

12. The method of claim 11, wherein the predetermined gesture event is a scroll up event, and the method further comprising:
displaying a multi-message window including the first message window and the second message window, when the scroll up event reaches a predetermined fixed position on the display screen.

13. The method of claim 12, further comprising switching the first message window to the second message window, when the scroll up event reaches a predetermined window switch position on the display screen.

14. The method of claim 13, further comprising displaying the first message window, when a key input is detected corresponding to returning to a previous message window.

15. The method of claim 11, wherein the at least a portion of the second message window is displayed on a higher layer of the first message window.

16. The method of claim 11, wherein the reception notification is displayed on a lower portion of the first message window in the form of one of a bar, a balloon, a floating icon, and a tab.

17. The method of claim 11, wherein, when a plurality of new messages are received, and the predetermined area is selected, a plurality of new message windows corresponding to the plurality of new message notifications are expanded in a spreading manner.

18. The method of claim 12, further comprising, when one of the first message window and the second message window is selected from the multi-message window, displaying the selected message window as a main message window and displaying an input field corresponding to the selected message window.

19. The method of claim 12, wherein when a request is detected for switching the multi-message window into a group message window, the multi-message window is switched into the group message window, and the group message window is displayed.

20. An article of manufacture for displaying a message by an electronic device, comprising a non-transitory machine readable medium containing one or more programs which when executed implements the steps of:
displaying a reception notification for a new message from a second person on a first message window including messages exchanged between a user and a first person on a display screen of the electronic device; and
displaying at least a portion of a second message window including the new message for a predetermined time on the display screen, when a predetermined gesture event detected on the reception notification occurs in a predetermined area of the display screen.
